(19) United States
(12) Patent Application Publication
(10) Pub. No.: US 2023/0228383 A1
(43) Pub. Date: Jul. 20, 2023

(54) HOLDER AND DISPLAY FOR COMPRESSED GAS CARTRIDGES

(71) Applicant: ROY KUSHNER, DOBBS FERRY, NY (US)

(72) Inventor: ROY KUSHNER, DOBBS FERRY, NY (US)

(21) Appl. No.: 18/094,236

(22) Filed: Jan. 6, 2023

Related U.S. Application Data
(60) Provisional application No. 63/300,041, filed on Jan. 16, 2022.

(51) Int. Cl. F17C 13/08

(52) U.S. Cl. CPC F17C 13/084; F17C 2201/058; F17C 2201/0109; F17C 2221/013; F17C 2205/0103

(57) ABSTRACT

A holder for compressed gas cartridges may consist of a geometric body with a plurality of elongated cylindrical holes, each hole may be adapted to removably engage the neck portion of a standard compressed gas cartridge. When the neck portion of a standard compressed gas cartridge is inserted into the elongated cylindrical hole in the geometric body, the compressed gas cartridge may be securely but removably attached to the geometric body. The angle and orientation of the compressed gas cartridges may form a support structure for the geometric body.

### CROSS-REFERENCE TO RELATED APPLICATIONS

This application claims the benefit of U.S. Provisional Application No. 63/300,041 filed Jan. 16, 2022.

### FIELD OF THE DISCLOSURE

This application relates generally to display and storage devices. More particularly the present disclosure relates to a geometric body with a plurality of holes adapted to removably engage the neck portion of standard compressed gas cartridges.

### BACKGROUND OF DISCLOSURE

Threaded and non-threaded CO2 cartridges are commonly used by cyclists to inflate their bike tires in case of a flat tire during a bicycle ride. These CO2 cartridges are single use, small, lightweight, and can inflate the bicycle tire in just a few seconds. This is accomplished through the use of an inflator tool which can open the cartridge and meter the flow of the compressed CO2 into a bicycle tire through the bicycle tire valve. This convenience is an improvement over portable hand pumps that are larger, heavier, and take much more effort and a much longer time to inflate a bicycle tire.

CO2 cartridges are frequently bought in multiple quantities, so that cyclists have spares ready in their tool kits. Purchasing CO2 cartridges in quantity, like many disposable products, allows the purchaser to save money when compared to purchasing individual items. While a cyclist may have a multitude of CO2 cartridges at any given time, these CO2 cartridges are typically handled and used only in the case of a flat tire. Once a CO2 cartridge is used, it is either discarded or recycled.

The question of how to store or display used or unused threaded CO2 cartridges by utilizing their threads has not been explored. While the male threaded neck of most standard CO2 cartridges are sized at ⅜-24 UNF (Unified National Fine Thread), there are no storage devices that have the corresponding female ⅜-24 UNF threads. The only devices currently adapted to the threads of compressed CO2 cartridges are machines or devices that have the purpose of utilizing the pressure differential between the compressed CO2 and the ambient atmospheric pressure surrounding the device, like a CO2 tire inflator; or devices that need, as a means for a process, the chemistry of the CO2 itself, like a carbonated beverage dispenser.

Many prior art approaches have been employed in the past, for displays and storage devices of all kinds. However, no prior art has been adapted specifically for the display or storage of compressed gas cartridges by inserting a plurality of cartridges into a geometric body. Consequently, there exists a need for a device that would allow a person to store or display their full or empty CO2 cartridges by means of inserting the cartridges into a geometric body.

The present invention is directed to overcoming the problem set forth above.

### Definitions

Unless otherwise defined, all technical and scientific terms used herein have the same meaning as commonly understood by one of ordinary skill in the art to which this invention belongs. Although methods and materials similar or equivalent to those described herein can be used in the practice or testing of the invention, suitable methods and materials are described below. In addition, the materials, methods, and examples are illustrative only and not intended to be limiting.

Geometric Body: A figure having three dimensions: length, width, and height; in other words, a figure that has volume and occupies a place in space.

### SUMMARY OF THE INVENTION

The present disclosure may include a way to removably engage a plurality of compressed gas cartridges. The device is designed to be easy to use, to removably but securely grip the neck of compressed gas cartridge, and to create a variety of geometries based on the shape of the geometric body and the quantity, location, and angle of holes in the geometric body into which the compressed gas cartridges may be removably engaged.

The invention provides a unique way to store or display used or unused compressed gas cartridges. The preferred embodiment of this invention illustrated herein, is adapted to display used or unused threaded compressed gas cartridges with a standard thread pitch of ⅜-24 UNF. Because of the unique thread pitch of most threaded CO2 compressed gas cartridges, there are currently no display or storage devices suitable for this purpose.

### BRIEF DESCRIPTION OF THE DRAWINGS

A complete understanding of the present variations and features thereof will be more readily understood by reference to the following detailed description when considered in conjunction with the accompanying drawings wherein:

FIG. 1 shows a top isometric view of the holder and display for compressed gas cartridges;

FIG. 2 shows bottom isometric view of the holder and display for compressed gas cartridges;

FIG. 3 shows a side elevation of the holder and display for compressed gas cartridges—and since all faces are identical, no other elevations are provided;

FIG. 4 shows front isometric view of the holder and display for compressed gas cartridges with compressed gas cartridges inserted into the threaded holes;

FIG. 5 shows a top isometric view of the holder and display for compressed gas cartridges with compressed gas cartridges inserted into the threaded holes;

FIG. 6 shows a standard ⅜-24 threaded neck compressed gas cartridge removably attached in a cut-away view of the holder and display for compressed gas cartridges; since all faces of the holder and display for compressed gas cartridges are identical, and the holder and display for compressed gas cartridges is bilaterally symmetrical, no other cross sections are provided;

FIG. 7A shows an isometric view of an alternate form for the holder and display for compressed gas cartridges with four identically shaped faces;

FIG. 7B shows an isometric view of the holder and display for compressed gas cartridges shown in FIG. 7A with a compressed gas cartridge attached to each face;

FIG. 8A shows an isometric view of an alternate form for the holder and display for compressed gas cartridges with eight identically shaped faces;

FIG. 8B shows an isometric view of the holder and display for compressed gas cartridges shown in FIG. 8A with a compressed gas cartridge attached to each face;

FIG. 9A shows an isometric view of an alternate form for the holder and display for compressed gas cartridges with twelve identically shaped faces;

FIG. 9B shows an isometric view of the holder and display for compressed gas cartridges shown in FIG. 9A with a compressed gas cartridge attached to each face;

FIG. 10 shows a cut-away view of a means for a standard un-threaded neck of a compressed gas cartridge to be removably attached to the holder and display for compressed gas cartridges;

FIG. 11 shows a cut-away view of an alternate means for a standard ⅜-24 threaded neck compressed gas cartridge to be removably attached to the holder and display for compressed gas cartridges;

### DETAILED DESCRIPTION

The specific details of the single embodiment or variety of embodiments described herein are to describe the system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art of having the benefit of the description herein.

In general, the variations disclosed may include a holder and display for compressed gas cartridges having a geometric shape capable of engaging either the threaded or unthreaded necks of standard CO2 compressed gas cartridges. The holder and display for compressed gas cartridges may be of nearly any shape, and may even consist of a geometric body that does not have identically shaped planar faces, a geometric body with more than one means to engage a standard CO2 cartridge on each face, or a geometric body with an amorphous smooth surface where no discernable planar faces exist. Cost, weight requirements and other application specifics may dictate material choices and manufacturing methodologies. The depth of the elongated cylindrical holes may vary according to the material type and the size of the holder and display for compressed gas cartridges; and while some of the drawing figures show blind holes, these holes could also be through-holes.

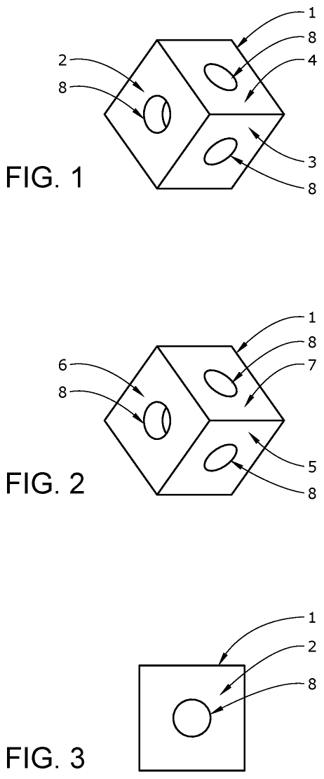

FIG. 1, shows a geometric body 1 having the form of a cube with six equal faces. FIG. 1 shows a front side 2 a right side 3, and a top side 4. Each side of the geometric body may have an elongated internally threaded cylindrical opening 8.

FIG. 2 shows a back side 5, a left side 6, and a bottom side 7 of the same geometric body 1. Each side of the geometric body may have an elongated internally threaded cylindrical opening 8.

FIG. 3 shows a side view of the front side 2. Since all faces of the geometric body 1 are identical, no other elevation is provided.

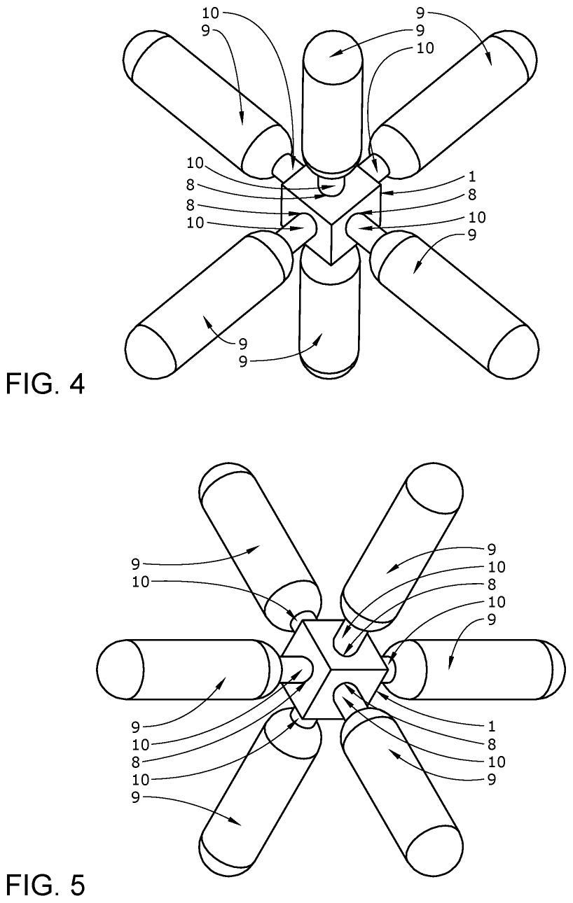

FIG. 4 shows a front isometric view of the geometric body 1 with common compressed gas cartridges 9 inserted into each of the elongated internally threaded cylindrical openings 8. Because many common compressed gas cartridges are available with a threaded neck 10, the elongated internally threaded cylindrical opening 8 may be internally threaded and adapted to receive the threaded neck of common compressed gas cartridges.

FIG. 5 shows a top isometric view of the geometric body 1 with common compressed gas cartridges 9 inserted into each of the elongated internally threaded cylindrical openings 8.

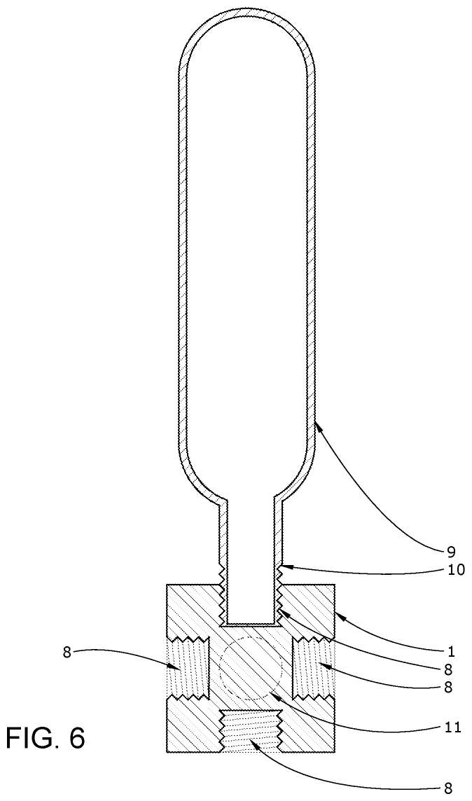

FIG. 6 shows a cut-away view of the geometric body 1 through the elongated internally threaded cylindrical openings 8 where the threaded neck 10 of a common compressed gas cartridge 9 may be threadably and removably connected. The dashed hidden line 11 indicates the elongated internally threaded cylindrical opening 8 beyond. Since all faces of the geometric body 1 are identical, geometric body 1 is bilaterally symmetrical, no other cut-away views are needed.

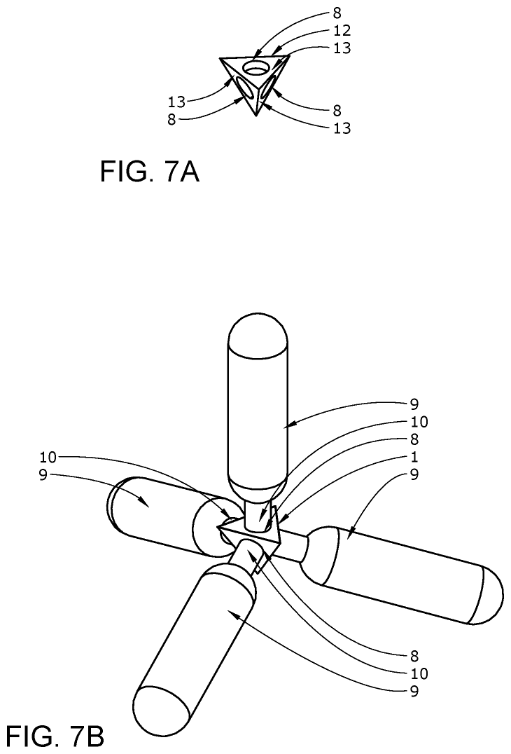

FIGS. 7A, 8A, and 9A, show alternate forms for the geometric body of a holder and display for compressed gas cartridges. Each face of the holder and display for compressed gas cartridges is shown with at least one elongated cylindrical opening 8, into which at least one standard compressed gas cartridge may be threadably and removably connected.

FIG. 7A is a geometric body 12 comprised of four identical faces, 13.

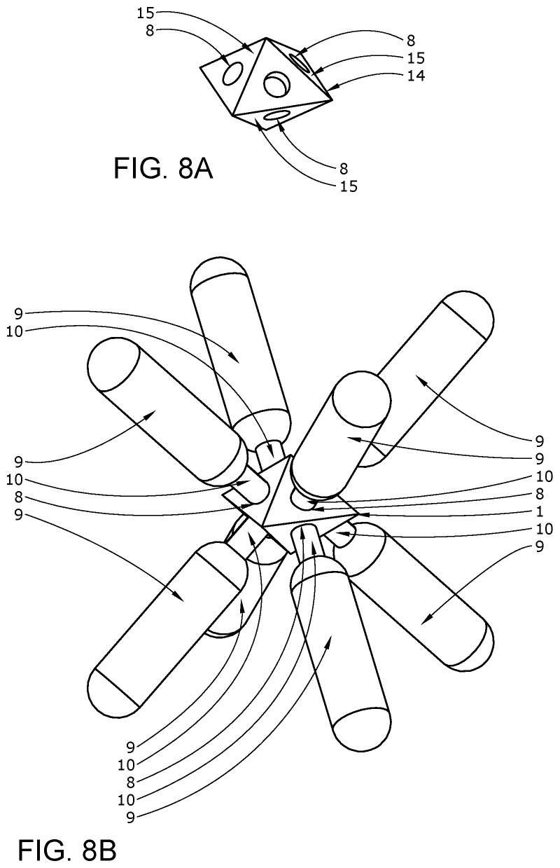

FIG. 8A is a geometric body 14 comprised of eight identical faces 15.

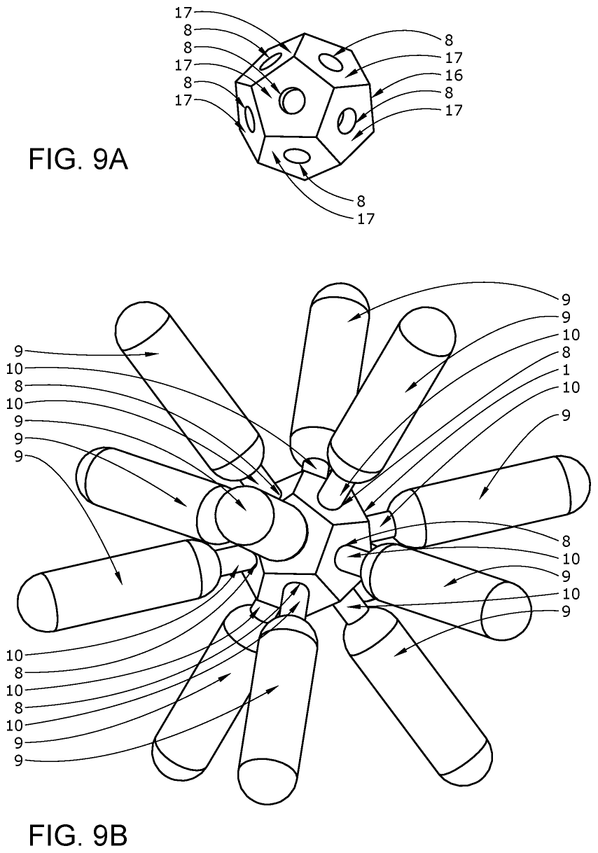

FIG. 9A is a geometric body 16 comprised of twelve identical faces 17. The attachment means of the standard compressed gas cartridges to the geometric bodies 12, 14, and 16 shown respectively in FIGS. 7B, 8B, and 9B may be the same as shown in FIG. 6, 10, or 11.

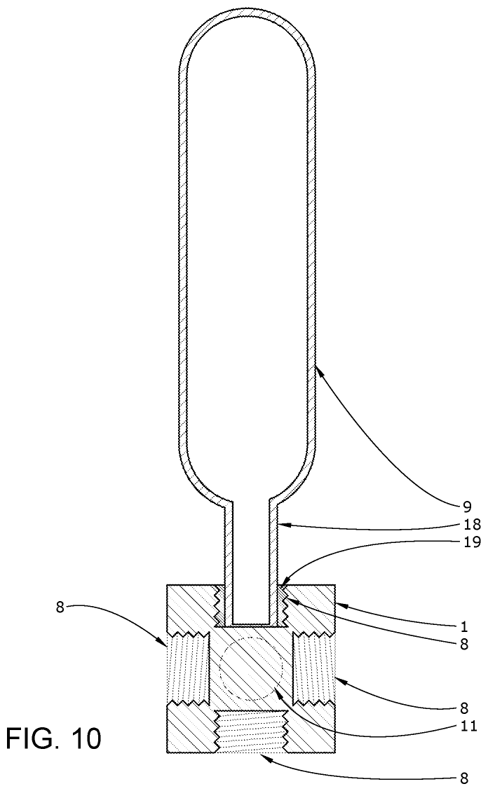

FIG. 10 shows a cut-away detail of another embodiment of the invention. In this embodiment of the invention, a compressed gas cartridge 9 has an un-threaded neck 18. An externally threaded deformable insert with an internal cylindrical opening 19 adapted to receive the unthreaded neck 18 of the compressed gas cartridge 9 may be threadably and removably engaged to the elongated internally threaded cylindrical openings 8.

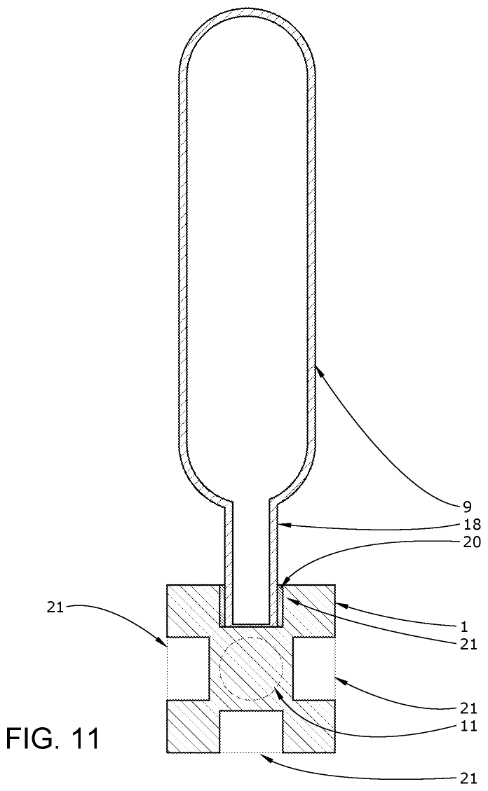

FIG. 11 shows a cut-away detail of another embodiment of the invention. In this embodiment of the invention, a compressed gas cartridge 9 may have an un-threaded neck 18. A deformable insert with an internal cylindrical opening 20 adapted to fit securely around the un-threaded neck 18 of the compressed gas cartridge 9 may have a means to securely engaged the geometric body 1, into an un-threaded elongated cylindrical opening 21. The attachment means shown in cut-away details shown in FIGS. 10 and 11, may be applied to any of the cylindrical openings 8 in any of the FIGS. illustrated herein.

What is claimed is:

1. A holder for compressed gas cartridges comprising:
a geometric body comprising:
a plurality of attachment means adapted to removably engage a neck of a compressed gas cartridge.

2. A holder for compressed gas cartridges as in claim 1 wherein said attachment means adapted to removably engage said neck of said compressed gas cartridge are elongated cylindrical holes or elongated cylindrical tubes with outer surfaces and inner surfaces.

3. A holder for compressed gas cartridges as in claim 1 wherein the axial orientation of said elongated cylindrical holes or elongated cylindrical tubes with outer surfaces and inner surfaces are arranged whereby at least three said compressed gas cartridges adapted with said necks having said means to removably engage said elongated cylindrical holes, substantially form a support structure for said geometric body.

4. A holder for compressed gas cartridges comprising:
a geometric body comprising:
at least four planar faces;
not less than three said planar faces each comprising at least one elongated cylindrical hole adapted with a means to removably engage a neck of a compressed gas cartridge.

5. A holder for compressed gas cartridges as in claim 4 wherein the axial orientation of said cylindrical holes are arranged in such a manner whereby at least one said compressed gas cartridge adapted with said neck having said means to removably engage said elongated cylindrical hole, along with a downward facing portion of said geometric body, substantially form a support structure for said geometric body.

6. A holder for compressed gas cartridges as in claim 4 wherein the axial orientation of said cylindrical holes are arranged whereby at least three said compressed gas cartridges adapted with said necks having said means to removably engage said elongated cylindrical holes, substantially form a support structure for said geometric body.

7. A holder for compressed gas cartridges as in claim 4 wherein all said planar faces are comprised of an elongated cylindrical hole.

8. A holder for compressed gas cartridges as in claim 7 wherein at least one said means to mechanically engage said neck of said compressed gas cartridge to said elongated cylindrical hole are female threads in said elongated cylindrical hole.

9. A holder for compressed gas cartridges as in claim 8 wherein at least one elongated cylindrical hole with said female threads is adapted to engage a corresponding male threaded rod whereby at least one additional holder and display for compressed gas cartridges may be threadably and removably affixed to said geometric body.

10. A holder for compressed gas cartridges as in claim 8 wherein said female threads are thread pitch ⅜-16 UNF and adapted to engage a male thread pitch ⅜-24 UNF neck of said compressed gas cartridge.

11. A holder for compressed gas cartridges as in claim 8 wherein said female threads are adapted to removably engage a threaded substantially compressible insert adapted to securely but removably engage said neck of said compressed gas cartridge.

12. A holder for compressed gas cartridges as in claim 4 wherein said elongated cylindrical hole is adapted with a means to mechanically engage said neck of said compressed gas cartridge.

13. A holder for compressed gas cartridges as in claim 4 wherein said elongated cylindrical hole is adapted with a means to engage a substantially compressible insert adapted with a means to securely but removably engage the neck of said compressed gas cartridge.

14. A holder for compressed gas cartridges as in claim 4 wherein said geometric body is comprised of at least six planar faces.

15. A holder for compressed gas cartridges as in claim 4 wherein said planar faces are substantially equal in shape and dimensional size.

16. A holder for compressed gas cartridges as in claim 4 wherein at least one said elongated cylindrical hole is substantially perpendicular to said planar face.

17. A holder for compressed gas cartridges as in claim 3 wherein said geometric body is comprised of molded, formed, or machined plastic, rubber, wood, or metal.

18. A holder for compressed gas cartridges as in claim 4 wherein at least one said elongated cylindrical hole is a through-hole without a bottom surface.

19. A holder for compressed gas cartridges as in claim 4 wherein at least one said planar face has a plurality of elongated cylindrical holes.

20. A holder for compressed gas cartridges comprising:
a geometric body comprising:
at least six planar faces, each said planar face comprising at least one elongated cylindrical hole adapted to removably engage a threaded neck of a compressed gas cartridge;
said planar faces are substantially equal in shape and dimensional size;
said elongated cylindrical holes are female threaded to thread pitch ⅜-24 UNF and adapted to removably engage a male thread pitch ⅜-24 UNF neck of said compressed gas cartridge;
whereby the angle and orientation of at least three said compressed gas cartridges adapted with said male thread pitch ⅜-24 UNF neck having a means to removably engage said female thread pitch ⅜-24 UNF elongated cylindrical holes, substantially form a support structure for said geometric body.
